(19) United States
(12) Patent Application Publication
(10) Pub. No.: US 2007/0168480 A1
(43) Pub. Date: Jul. 19, 2007

(54) Interactive Robot Creation

(75) Inventors: Todd S. Biggs, Kirkland, WA (US); Matthew C. Carlson, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/275,558

(22) Filed: Jan. 13, 2006

(51) Int. Cl. G06F 15/173

(52) U.S. Cl. 709/223

(57) ABSTRACT

Interactive robot (BOT) creation is described. A BOT is an automated computer program implemented on a presence-based network, such as an instant messaging (IM) network or voice over IP (VoIP) network. The BOT is implemented to interact with a user via a direct two-way communication to gather data. The data that is gathered is then used by the BOT to automatically create a new, user-defined BOT implemented on the same presence-based network.

### BACKGROUND

A BOT (which is short for “robot”) is an automated application or program implemented within a presence-based, two-way communication network such as an instant messaging (IM) or voice over IP network (VoIP) with which a user can interact. The BOT interacts with the user in such a way as to appear to be just like any other user on the network. BOTs may be simple in nature, providing simplistic conversational text exchange between the BOT and a user, or may be more complex, enabling the integration, for example, of audio and video within an exchange between a BOT and a user. BOTs can be configured to interact with users in various ways. For example, a BOT may be programmed to answer questions about movie show times, to search the web, or to simply chat with users. While many users enjoy interacting with BOTs, BOTs are difficult and time consuming to create, requiring both programming skills and access to specialized BOT development tools.

### SUMMARY

The Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Interactive robot creation is described. A robot (BOT), which is an automated, interactive computer program implemented on a presence-based network, is configured to gather data from a user, and use the data that is gathered to create a new, user-defined BOT to be implemented on the presence-based network. A BOT may be created to interact via any type of two-way communication network, such as, but not limited to, an instant messaging network or a VoIP network. Data that may be gathered may include, for example, a name, an ID, and a password to be associated with the new BOT; a personality type to be associated with the new BOT; a knowledge base and/or a data source to be associated with the new BOT; selection of one or more standard features (e.g., searching or alert generation); data input such as RSS feeds; and/or reporting parameters. Once created, the new, user-defined BOT is automatically made available such that other users may interact with the new, user-defined BOT.

### BRIEF DESCRIPTION OF THE DRAWINGS

FIG. 1 is a pictorial diagram that illustrates an exemplary network environment in which interactive BOT creation may be implemented.

FIG. 2 is a block diagram that illustrates an exemplary use of a BOT factory to create a user-defined BOT.

FIG. 3 is a pictorial diagram that illustrates an exemplary conversation between a user and a BOT factory.

FIG. 4 is a pictorial diagram that illustrates an exemplary conversation between a user and a BOT factory.

FIG. 5 is a block diagram that illustrates select components of an exemplary BOT server configured to support interactive BOT creation.

FIG. 6 is a flow diagram that illustrates an exemplary method for interactive BOT creation.

### DETAILED DESCRIPTION

Interactive robot (BOT) creation as described below provides a mechanism by which a user may interact with a BOT to create and publish a new, user-defined BOT. A BOT is an automated application or program with which a user can directly interact via a presence-based two-way communication network as if the BOT were any other user on that network. The following discussion is directed to interactive BOT creation. While features of interactive BOT creation can be implemented in any number of different computing environments, they are described in the context of the following exemplary implementations.

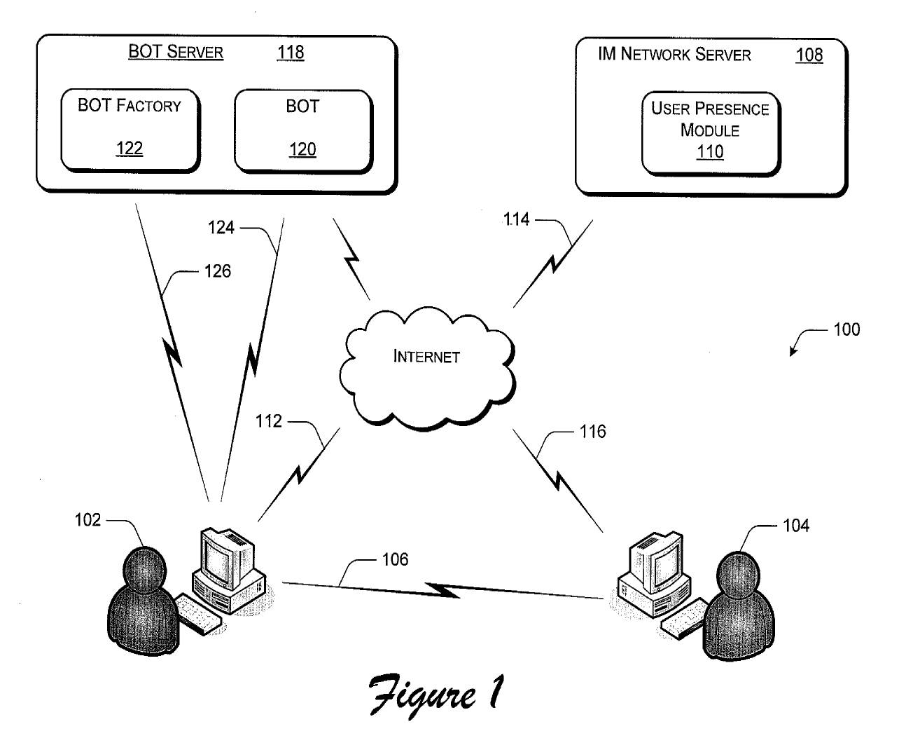

FIG. 1 illustrates an exemplary network environment 100 in which interactive BOT creation may be implemented. Peer-to-peer, two-way communication may be established between users within network environment 100. For example, user 102 and user 104 may engage in a two-way conversation (as indicated by communication link 106). In the illustrated example, instant messaging (IM) network server 108 includes a user presence module 110, via which users can establish “buddy” lists, and determine whether or not one or more of their buddies are online and available to interact with. For example, when user 102 is online, IM network server 108 is aware of user 102 via an Internet connection, represented by communication links 112 and 114. Similarly, when user 104 is online, IM network server 108 is aware of user 104 via an Internet connection, represented by communication links 116 and 114. Upon request from either user 102 or user 104, IM network server 108 may facilitate establishment of a direct communication link 106 between user 102 and user 104. Functionality of an IM network to establish a peer-to-peer communication link is well-known to those skilled in the art.

Network environment 100 also includes BOT server 118, which includes one or more BOTs 120 and BOT factory 122. A BOT is an application or program with which a user can interact via a direct communication link. For example, in addition to being aware of the presence of user 102 and user 104, IM network server is also aware of the presence of BOT 120. Accordingly, user 102 can request that IM network server 108 facilitate establishment of a direct communication link 124 between user 102 and BOT 120. Once this link is established, user 102 and BOT 120 are able to interact as if BOT 120 were another user.

BOT factory 122 is implemented as a BOT, and is available for interaction via IM network server 108. For example, a direct communication link 126 may be established between user 102 and BOT factory 122 to enable user 102 to interact with BOT factory 122. BOT factory 122 is configured to request information from a user, and based on the received information, create a new, user-defined BOT, which is then hosted on BOT server 118, and available for interaction with users via the IM network.

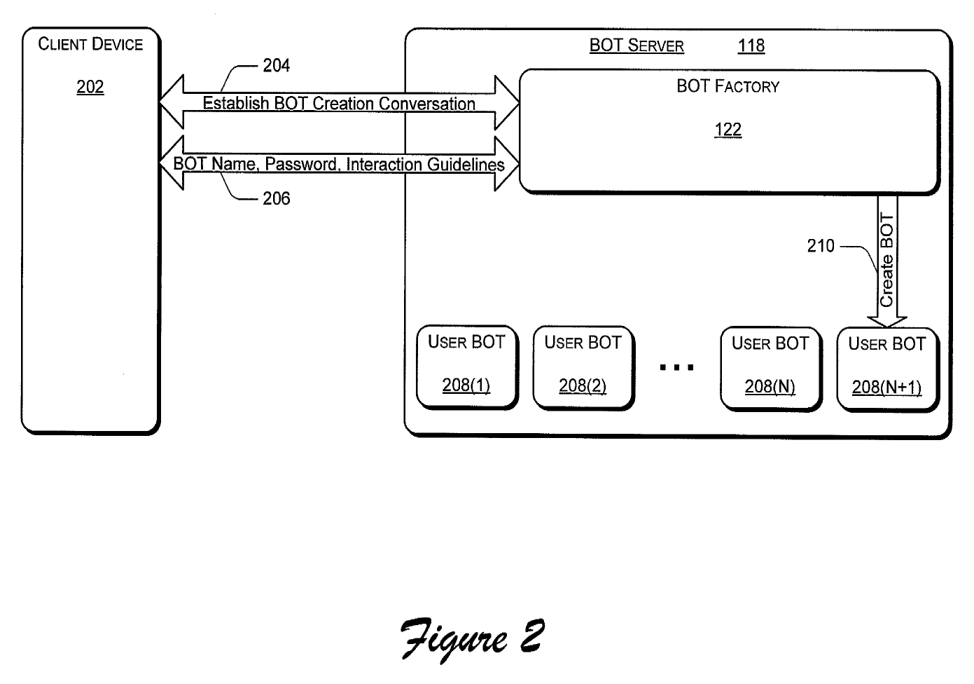

FIG. 2 illustrates the use of a BOT factory to create a BOT. Client device 202 represents any type of computing device via which a user can establish a direct communication link with another user via a presence-based network (e.g., an IM network), specifically with BOT factory 122. For example, client device 202 may be implemented as a personal computer, an Internet-enabled smart phone, an Internet-enabled personal digital assistant (PDA), a telephone, and so on.

Arrow 204 indicates that a conversation is established between user device 202 and BOT factory 122. As described above with reference to FIG. 1, such a conversation may be established via an instant messaging network, or other type of presence-based network. In the case of a VoIP network, the conversation may be established based on the user dialing a particular phone number associated with BOT factory 122, and may be configured with speech recognition technology to enable speech-to-text and/or text-to-speech interaction. The BOT factory 122 is configured to gather data to be used to create a new, user-defined BOT. Accordingly, in the illustrated example, the BOT factory 122 requests, and a user provides this data. For example, arrow 206 indicates that the user provides a name to be associated with the new BOT, a password to enable the user access to modify the BOT once it is created, and interaction guidelines to be associated with the new BOT.

In addition to maintaining BOT factory 122, BOT server 118 (which may be implemented as one or more physical devices), also maintains user-defined BOTS 208(1), 208(2), . . . , 208(N). After receiving the requested data, BOT factory 122 creates a new user BOT 208(N+1), as indicated by arrow 210.

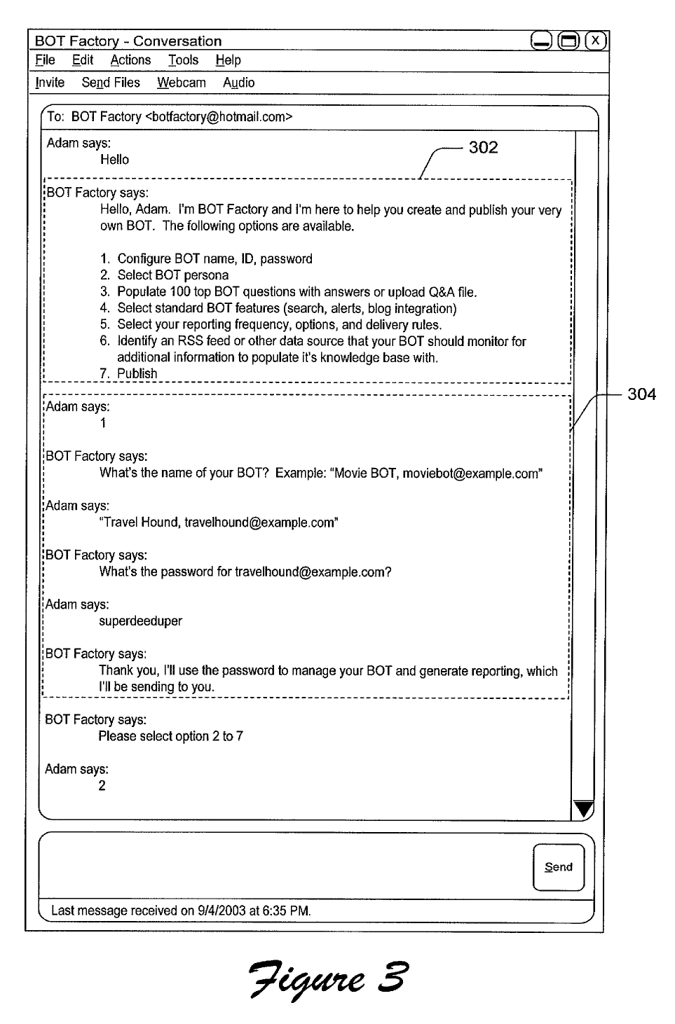

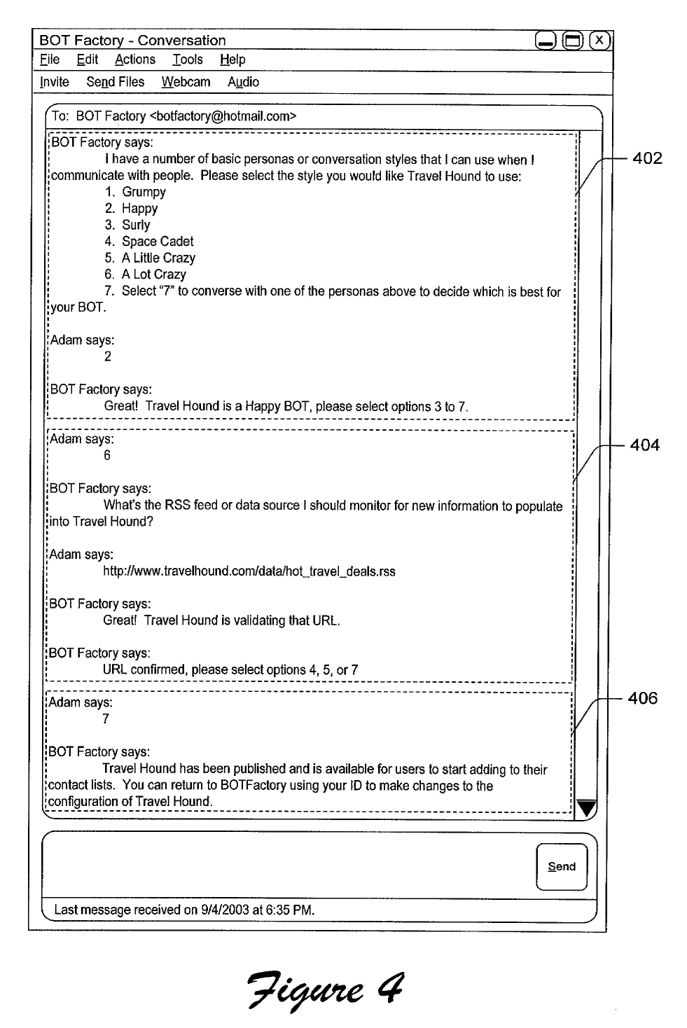

FIGS. 3 and 4 illustrate an exemplary instant messaging conversation between a user (Adam) and a BOT factory. After the conversation is established, the BOT factory introduces itself, as indicated by the text in box 302. In the illustrated example, the introductory text includes a list of options available to the user, and indicates the data that will be needed to create a BOT. For example, a user may be able to specify a name, ID, and password to be associated with the BOT; select a personality type to be associated with the BOT; specify questions and answers for the BOT to know; and select features, reporting characteristics, and data sources for the BOT. For example, the text in box 304 illustrates interaction that may occur between the BOT factory 122 and a user to establish a name, ID, and password for a new BOT to be created.

Referring to FIG. 4, the text in box 402 illustrates an example interaction that may occur between the BOT factory 122 and a user to establish a persona to be associated with the new BOT. Similarly, the text in box 404 illustrates an example interaction that may occur between the BOT factory 122 and a user to identify a data source that the new BOT may be configured to monitor to add to its knowledge base. Finally, the text in box 406 illustrates an example interaction that may occur between the BOT factory 122 and the user when the user is ready to have the new BOT created and made available.

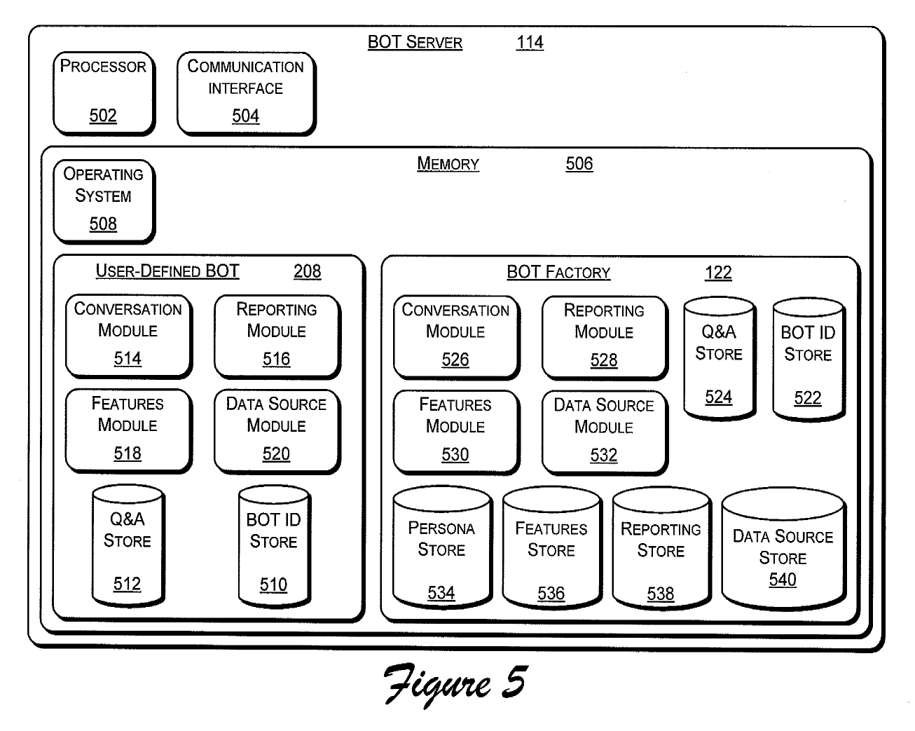

FIG. 5 illustrates select components of an exemplary BOT server 118 implemented to support interactive BOT creation, as described herein. BOT server 118 includes a processor 502, a communication interface 504, and a memory 506. Communication interface 504 enables one or more components of BOT server 118 to send and/or receive data, for example, via the Internet, an instant messaging network, a telephone network, or other presence-based network. Operating system 508, one or more user-defined BOTs 208, and BOT factory 122 are stored in memory 506 and executed on processor 502. Memory 506 is representative of any type or combination of memory, such as, but not limited to, random access memory (RAM), a hard disk, or removable memory media. Furthermore, although illustrated as a single entity, BOT server 118 may be implemented as a combination of any number of computing devices, with components shown in FIG. 5 distributed in any way across the computing devices.

User-defined BOT 208 includes BOT ID store 510, Q&A store 512, conversation module 514, reporting module 516, features module 518, and data source module 520. The illustrated components of user-defined BOT 208 are for illustrative purposes only, and are not intended to limit the scope of interactive BOT creation, as described herein. In alternate implementations, a user-defined BOT may include additional components not shown in FIG. 5, or may not include all of the components shown in FIG. 5.

In an exemplary implementation, BOT ID store 510 is configured to maintain a name, ID, and password associated with the user-defined BOT 208. For example, the BOT created as shown in FIGS. 3 and 4 has the name “Travel Hound”, the ID “travelhound@example.com”, and the password “superdeeduper”. BOT ID store 510 may also include any other type of identifying data associated with the user-defined BOT 208. Q&A store 512 is configured to maintain a knowledge base of questions and answers for the user-defined BOT 208. When a user, interacting with user-defined BOT 208 asks a question, the response given by user-defined BOT 208 is based on data stored in Q&A store 512.

Conversation module 514 is a code module that enables user-defined BOT 208 to converse with other users. In an exemplary implementation, conversation module 514 includes procedural code that enables user-defined BOT 208 to interpret questions received from a user, and to respond to those questions, based on data stored in Q&A store 512. Reporting module 516 is a code module that defines how (or if) user-defined BOT 208 provides reports to the user who created user-defined BOT 208. For example, user-defined BOT 208 may send a report by email (or other delivery mechanism) at regular intervals (e.g., daily, weekly, monthly) to inform the BOT creator of how many conversations the user-defined BOT 208 has participated in, and with whom.

Features module 518 is a code module that enables user-defined BOT 208 to implement any number of additional features, such as, for example, a search, blog integration, or alert generation. Similarly, data source module 520 is a code module that enables user-defined BOT 208 to gather data from any number of other sources (e.g., an RSS feed or any other APT with open access) to be included in the knowledge base (e.g. Q&A store 512) associated with user-defined BOT 208.

Because BOT factory 122 is also a BOT, it includes components similar to those described above with reference to user-defined BOT 208. For example, BOT factory 122 includes BOT ID store 522, Q&A store 524, conversation module 526, reporting module 528, features module 530, and data source module 532. These components provide the same functionality to BOT factory 122 as the respective components of user-defined BOT 208 (i.e., BOT ID store 510, Q&A store 512, conversation module 514, reporting module 516, features module 518, and data source module 520).

In addition, BOT factory 122 also includes additional components. Namely, persona store 534, features store 536, reporting store 538, and data source store 540. Persona store 534 is configured to maintain various code segments that may be used to generate a conversation module, such as conversation module 514. In an exemplary implementation, BOTs implemented with each of the various code segments will have different “personalities”. For example, code segments may be available for generating a BOT with a grumpy personality, a happy personality, or a surly personality. As an example, a user may ask the BOT a question such as, “How are you?” A BOT with a grumpy personality may respond with, “I'm not in the mood for small talk—what do you want?” A BOT with a happy personality may respond with, “Great! Thanks for asking.” A BOT with a surly personality may respond with, “None of your business!” In an exemplary implementation, persona store 534 maintains several common user interactions that are grouped by personality. For example, persona store 534 may maintain four responses to the question, “How are you”, namely, response A, response B, response C, and response D. Response A may be associated with a happy personality; response B and response C may be associated with a grumpy personality; and response C and response D may be associated with a surly personality. Similar mappings may exist for different interactions and different personas.

In the described exemplary implementation, BOT factory 122 is configured to provide users with a choice of available personas. Based on which option the user selects, the new BOT will be created to include a corresponding conversation module selected from the persona store 534. Similarly, features store 536 includes code modules for implementing any number of standard features within a user-defined BOT. As a user defines a new BOT, for any of the available features that the user selects, code modules are copied from features store 536 for inclusion as a features module in the new BOT. The same is also true for reporting store 538 and data source store 540.

In an alternate implementation, one or more of persona store 534, features store 536, reporting store 538, and data source store 540 are maintained separate from BOT factory 122, but may be accessed by BOT factory 122. For example, persona store 534, features store 536, reporting store 538, and data source store 540 may be maintained in memory 506 and accessed by BOT factory 122. Furthermore, user-defined BOT 208 may be implemented to access code modules stored in one or more of persona store 534, features store 536, reporting store 538, and data source store 540, rather than including a full copy of a code module.

Methods for implementing interactive BOT creation may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

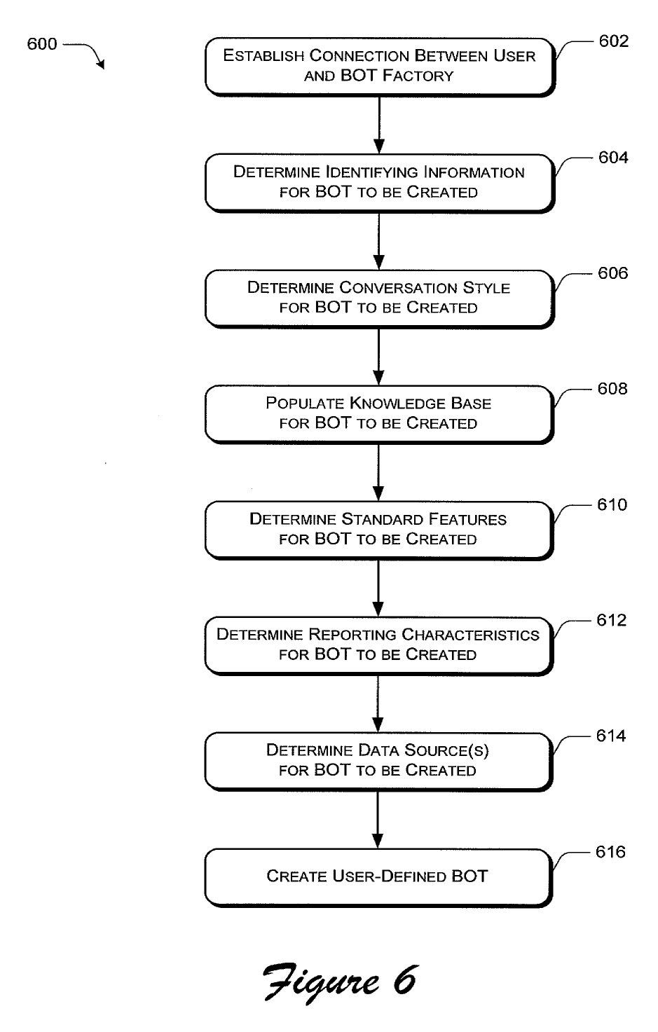

FIG. 6 illustrates an exemplary method 600 for interactive BOT creation. FIG. 6 is a specific example of interactive BOT creation, and is not to be construed as a limitation. The order in which the method blocks are described is not intended to be construed as a limitation, and any number of the described method blocks can be combined in any order to implement the method. Furthermore, the method can be implemented in any suitable hardware, software, firmware, or combination thereof.

At block 602, a connection between a user and a BOT factory is established. The BOT factory is a BOT that is configured to interact with a user to help the user create a new, user-defined BOT. For example, user 102 submits to IM network server 108, a request to establish a connection with BOT factory 122. Based on that request, IM network server 108 facilitates establishment of a direct connection 126 between user 102 (e.g., a device being used by user 102) and BOT factory 122.

At block 604, identifying information associated with the BOT to be created is determined. For example, BOT factory 122 requests a name, ID, and password to be associated with the new BOT, and the user provides the requested data.

At block 606, a conversation style for the BOT to be created is determined. For example, BOT factory 122 presents a list of available conversation styles (also referred to herein as “personas”), based on data stored in persona data store 534. The user then selects the persona or conversation style to be implemented for the BOT that is being created.

At block 608, a knowledge base for the BOT to be created is populated. For example, the user may enter a series of questions and corresponding answers for the BOT to be aware of. Alternatively, the user may upload to BOT factory 122, a file containing a list of questions and corresponding answers.

At block 610, standard features to be implemented as part of the BOT to be created are determined. For example, BOT factory 122 may provide the user with a list of available standard features, and the user may select one or more of the available features to be implemented as part of the BOT to be created.

At block 612, reporting characteristics to be associated with the BOT to be created are determined. For example, the user may specify what type of data is to reported, a frequency with which the data is to be reported, and a means by which the data is to be reported.

At block 614, data sources for the BOT to monitor are determined. For example, the user may specify a rich site summary (RSS) feed, blog, or other type of data source for the BOT to monitor and extract data from.

At block 616, the user-defined BOT is created. For example, BOT factory creates a new, user-defined BOT 208. The identifying information gathered as described above with reference to block 604 is maintained in BOT ID store 510; a code module corresponding to the conversation style determined as described above with reference to block 606 is implemented as conversation module 514; questions and answers gathered as described above with reference to block 608 are maintained in Q&A store 512; code modules corresponding to standard features determined as described above with reference to block 610 are implemented as features module 518; code modules implementing the reporting characteristics determined as described above with reference to block 612 are implemented as reporting module 516; and code modules configured to monitor data sources determined as described above with reference to block 614 are implemented as data source module 520. Furthermore, the ID associated with the newly created BOT is made available to IM network server 108 so that users are able to access and interact with the newly created BOT.

Although embodiments of interactive BOT creation have been described in language specific to structural features and/or methods, it is to be understood that the subject of the appended claims is not necessarily limited to the specific features or methods described. Rather, the specific features and methods are disclosed as exemplary implementations of interactive BOT creation.

1. A method, implemented at least in part by a first automated interactive computer program, comprising:
automatically participating in a communication with a client device, via a presence-based network;
receiving data via the communication that defines parameters for a second automated interactive computer program to be created;
automatically creating, in the presence-based network, the second automated interactive computer program based on the data that is received.

2. The method as recited in claim 1, wherein the presence-based network comprises an instant messaging network.

3. The method as recited in claim 1, wherein the presence-based network comprises a voice over IP (VoIP) network.

4. The method as recited in claim 1, wherein the parameters for a second automated interactive computer program comprise at least one of identifying information, a persona, a knowledge base, a knowledge source, a selection of a search feature, a selection of an alerts feature, a selection of a blog integration feature, or reporting characteristics.

5. The method as recited in claim 4, wherein the identifying information comprises at least one of a BOT name, a BOT identifier, or a password.

6. The method as recited in claim 4, wherein the knowledge base comprises at least one of a series of received questions and corresponding answers, or a file containing a series of questions and corresponding answers.

7. The method as recited in claim 4, wherein the knowledge source comprises at least one of a rich site summary (RSS) feed, a public application programming interface (API), or a web log (blog).

8. The method as recited in claim 1, wherein automatically creating, in the presence-based network, the second automated interactive computer program based on the data that is received comprises:
identifying an available code module that corresponds to the data that is received; and
creating a BOT that includes the code module that corresponds to the data that is received.

9. The method as recited in claim 1, further comprising publishing the second automated interactive computer program so that the second automated interactive computer program is available for automated interaction via the presence-based network.

10. The method as recited in claim 9, wherein publishing the second automated interactive computer program comprises registering the second automated interactive computer program with an instant messaging network.

11. A system comprising a BOT, wherein the BOT is configured to:
gather data via a presence-based network conversation with a user; and
based on the data that is gathered, create a new BOT.

12. The system as recited in claim 11, wherein the new BOT is configured to engage in an automated instant messaging conversation via the presence based network.

13. The system as recited in claim 11, wherein the presence-based network comprises a voice over IP (VoIP) network, and the new BOT is configured to engage in automated telephone conversations via the VoIP network.

14. The system as recited in claim 11, wherein the BOT is configured to gather data by requesting and receiving at least one of identifying data to be associated with the new BOT, a communication style to be associated with the new BOT, a knowledge base to be associated with the new BOT, an indication of a standard feature to be associated with the new BOT, reporting characteristics to be associated with the new BOT, or a data source to be monitored by the new BOT.

15. The system as recited in claim 11, wherein the BOT is configured to gather data by:
presenting the user with an indication of a plurality of available code modules; and
receiving an indication of a user selection of a particular one of the available code modules.

16. The system as recited in claim 15, wherein the BOT is configured to create the new BOT by creating a new computer program that includes a copy of the particular one of the available code modules.

17. One or more computer-readable media comprising computer-readable instructions which, when executed, cause a computer system to:
automatically interact with a user in a two-way conversation via a presence-based network;
receive data from the user via the two-way conversation; and
based on the data that is received, automatically create a BOT that is configured to automatically interact with users via two-way conversations via the presence-based network.

18. The one or more computer-readable media as recited in claim 17, wherein the presence-based network comprises at least one of an instant messaging network or a voice over IP network.

19. The one or more computer-readable media as recited in claim 17, wherein the two-way conversation comprises an instant messaging conversation.

20. The one or more computer-readable media as recited in claim 17, wherein the two-way conversation comprises an automated telephone conversation.
